(19) United States
(12) Patent Application Publication
(10) Pub. No.: US 2005/0061065 A1
(43) Pub. Date: Mar. 24, 2005

(54) Apparatus and method for function testing

(75) Inventor: Paul D. Terpstra, Janesville, WI (US)

Correspondence Address: FOLEY & LARDNER, 321 NORTH CLARK STREET, SUITE 2800, CHICAGO, IL, 60610-4764, US

(73) Assignee: Gilman Engineering & Manufacturing Co., LLC

(21) Appl. No.: 10/668,890

(22) Filed: Sep. 23, 2003

(51) Int. Cl. G01L 3/26

(52) U.S. Cl. 73/117

(57) ABSTRACT

An apparatus for function testing rack and pinion systems having a linear servo motor. A single actuator provides force to both ends of the rack and a linear motor to provide resistive force to the rack. The linear motor is used to apply the required forces. In a preferred embodiment, the actuator is a generally “U” shaped structure mounted onto a linear motor stage. A force transducer is placed at each end of the generally “U” shaped structure between the structure and the rack to monitor the force being applied to the rack.

### FIELD OF THE INVENTION

The present invention relates generally to function testing.

### BACKGROUND OF THE INVENTION

Rack and pinion gears or assemblies are used to convert rotation into linear motion. A common method to conduct a function test on rack and pinion assemblies utilizes two servo-controlled hydraulic cylinders pushing against each end of the rack as a separate servo motor rotates the pinion. Load cells between the hydraulic cylinder and the rack provide a feedback signal that is used by the servo controller to maintain a constant force against the rack. A torque transducer provides a feedback signal showing the torque required to turn the pinion. The motion and required drive torque of the pinion are compared against the force and position of the rack to verify the correct operation of the assembly. An alternative method employs, in place of the two hydraulic cylinders, two ball-screw driven actuators, or electric cylinders, that push springs against the opposite ends of the rack (FIG. 1). The compression of the springs provides the desired force.

Disadvantages of the hydraulic servos described above include, for example, the inherent leaks and housekeeping associated with hydraulic systems. Hydraulic servo systems are very sensitive to contamination of the system itself. Thus, in addition to general maintenance for the hydraulic system (pump, valves, filters, etc.), a high level of maintenance is required to prevent or remedy contamination. The disadvantage of the ball screw actuators is that the inherent ball screw error (non-linearity) can cause errors in the force applied to the rack. Ball screw drives also have inherent mechanical vibrations (or “rumble”) that can be picked up by the load cell transducers, causing small errors in the readings and ultimately the test results.

In order for the ball screw actuator of the prior art to apply a constant force to the rack, the ball screw actuator must be driven into the rack until the spring compresses and generates the force signal to the motion control operating the ball screw actuator. The control mechanism inherent in the use of a ball screw actuator creates continuous fluctuations in the force. Maintaining the desired force level, while the rack is being driven by the pinion, is a very dynamic operation.

Therefore, there is a need for a method and device for function testing rack and pinion assemblies that provides low maintenance, high durability, and accurate measurements.

### SUMMARY OF THE INVENTION

The present invention relates to a method and device for function testing rack and pinion assemblies that provides low maintenance, high durability, and accurate measurements for the function testing of rack and pinion systems. One embodiment of the present invention utilizes a linear servo motor to provide the required force and motion for this system. The linear servo motor applies a constant resistive force to the rack. The resistive force applied to the rack is controlled by regulating the electrical current flowing to the linear motor. Application of a known current at the required voltage generates a known resistive force based upon the force constant of the motor. An actuator located at both ends of the rack provides the applied force. A force transducer allows minor adjustments to be made in the resistive force exerted by the linear motor. A force signal from the force transducer reduces or increases the current flowing to the linear motor to maintain the desired force. Another embodiment of the present invention relates to use of a generally “U” shaped structure as the actuator for function testing of a device.

### BRIEF DESCRIPTION OF THE DRAWINGS

FIG. 1 is a diagram of a ball screw control architecture of the prior art.

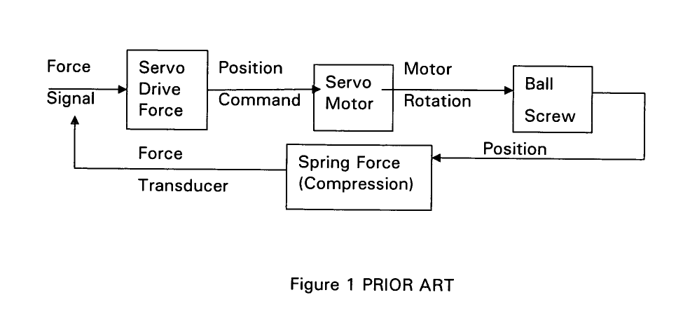

FIG. 2 is a diagram of a function test station with a generally “U” shaped structure mounted onto a linear motor stage in accordance with the principles of the present invention.

FIG. 3 is a schematic representation of a test system in accordance with the principles of the present invention.

FIG. 4 is a diagram of a linear motor control architecture in accordance with the principles of the present invention.

### DETAILED DESCRIPTION OF THE PREFERRED EMBODIMENTS

Given the disadvantages of the prior art, there is a need for a more efficient apparatus to function test various systems. One aspect of the present invention relates to the use of a linear servo motor. Another aspect concerns the use of a generally “U” shaped structure as an actuator. A preferred embodiment of the present invention involves the use of a linear servo motor and the generally “U” shaped structure to function test a rack and pinion assembly.

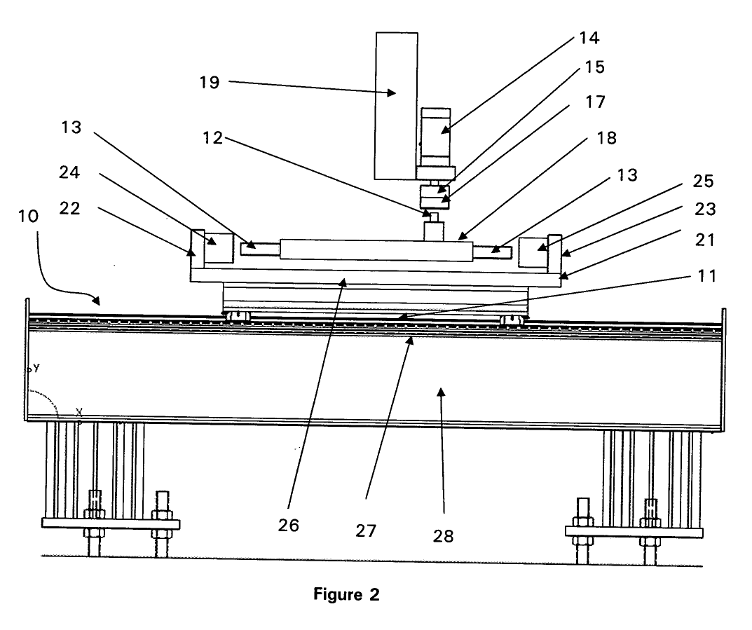

Referring to the preferred embodiment shown in FIG. 2, a function test station 10 in accordance with the principles of the present invention utilizes a generally “U” shaped structure 21 to provide the force to both ends of a rack 13 and a linear motor 11 to provide the resistive force to the rack 13. The linear motor 11 is used to apply the required forces. A pinion drive 14 is connected to a torque transducer 15. A pinion coupling 17 connects the pinion drive 14 via the torque transducer 15 to an input shaft 12 of an rack and pinion assembly 18. The rack 13 of a rack and pinion assembly 18 is positioned within two arms 22, 23 of the generally “U” shaped structure 21.

The generally “U” shaped structure 21 is designed so that each of the two arms 22, 23 engages an end of the rack 13. The arms 22, 23 are connected via a base 26 which allows for a single source of force to apply force to either end of the rack 13 without the need for adjusting or changing equipment. Each arm 22, 23 of the generally “U” shaped structure 21 has a force transducer 24, 25, for example a load cell, positioned to engage the ends of the rack 13. The force transducers 24, 25 are placed at each end of the arms 22, 23 of the generally “U” shaped structure 21, between the arms 22, 23 and the rack 13 to monitor the force applied to the rack 13.

In a preferred embodiment, the force transducers 24, 25 are capable of providing feedback to a controller such as but not limited to a supporting computer test system to allow for precise control of the force applied to the rack 13. The generally “U” shaped structure 21 is mounted onto a linear motor stage 27 made up of, for example but not limited to a linear actuator such as a linear motor 11, linear bearings, and an encoder. The linear motor stage 27 is supported by a support structure 28.

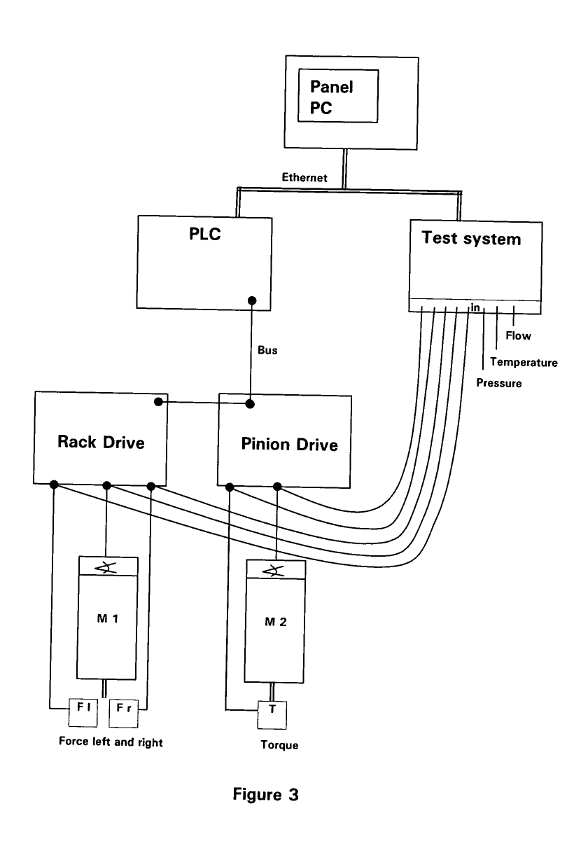

FIG. 3 shows a schematic representation of a test system in accordance with the principles of the present invention for use with a rack and pinion assembly. In a preferred embodiment, the testing system includes a function test station as described previously that is controlled by the supporting computer test system run on a computer system, preferably an industrial personal computer (PC). The computer system may include the functionality of a programmable logic controller (PLC) by incorporating special software and/or hardware. The system may further include a pallet and a pallet index unit to support and transfer the rack and pinion assembly 18 throughout the test system. This pallet would preferably be equipped with a radio frequency (RF) tag to track and record test results. A pallet index may also be provided to move the pallet into the test position. A hydraulic (steering) fluid adapter may also be provided to connect to the inlet and outlet ports if the rack and pinion assembly 18 is hydraulically assisted as in the case of an automobile steering gear. A linear actuator 19, preferably pneumatically operated, may also be required to bring the pinion drive 14, torque transducer 15, and pinion coupling 17 into a mating position with the input shaft 12 of the rack and pinion assembly 18.

The testing sequence begins with the rack and pinion assembly 18 positioned inside the test system. The rack and pinion assembly 18 may be positioned automatically or manually. The model identification of the rack and pinion assembly 18 may be read from the RF tag along with the condition of the rack and pinion assembly 18. If the rack and pinion assembly 18 is good and to be tested the test is begun. If hydraulics are utilized, the hydraulic fluid adapters connect to the inlet and outlet ports. The linear actuator 19 brings the pinion coupling 17 into contact with the input shaft 12 of the rack and pinion assembly 18. If hydraulics are utilized, the rack and pinion assembly 18 is filled with hydraulic fluid while the rack is driven in one direction and then the other by the pinion drive 14. During the fill the linear motor stage 27 will move the “U” shaped structure 21 so that neither force transducer 24, 25 contacts the ends of the rack 13. After the fill is complete, if required, the rack 13 will be moved to its center position and the linear motor stage 27 will move the “U” shaped structure 21 so that one of the force transducers (i.e. 24) comes in contact with the appropriate end of the rack 13. While the pinion input shaft 12 is held stationery by the pinion drive 14 the linear motor stage 27 will apply a specified force against the end of the rack 13 utilizing the “U” shaped structure 21. This force is verified and corrected using the signal from the appropriate force transducer 24, 25. The rack 13 is then driven against the actuator, preferably a generally “U” shaped structure 21, by the pinion drive 14. As the rack 13 is moved, the force applied to the rack 13 is monitored and maintained by the linear motor stage 27 using the signal from the appropriate force transducer 24, 25.

When the motion is completed the rack 13 and the generally “U” shaped structure 21 are returned to the starting position. While the pinion input shaft 12 is held stationery by the pinion drive 14, the linear motor stage 27 will apply a specified force against the opposite end of the rack 13 utilizing the generally “U” shaped structure 21. This force is verified and corrected using the signal from the second force transducer (i.e. 25). The rack 13 is then driven in the opposite direction against the generally “U” shaped structure 21 by the pinion drive 14. As the rack 13 is moved, the force applied to the rack 13 is monitored and maintained by the linear motor stage 27 using the signal from the appropriate force transducer 24, 25. When the motion is completed the rack 13 and generally “U” shaped structure 21 are returned to the starting position and the linear actuator 19 retracts the pinion drive 14 away from the pinion input shaft 12.

If hydraulics are utilized, the rack and pinion assembly 18 is then purged of oil. The measured results of the tests are compared to the set parameters and the acceptability of the rack and pinion assembly 18 is determined. The RF tag, if utilized, is written with the test results

It is possible, that additional tests may be completed on the rack and pinion assembly 18 such as driving the generally “U” shaped structure 21 against the rack 13 with the pinion drive 14 de-coupled from the pinion input shaft 12. The force measured by the appropriate force transducer 24, 25 during this motion would be compared against set parameters and the acceptability of the rack and pinion assembly 18 determined.

In a preferred embodiment, all of the evaluated data is stored locally in a database file with date, time, and serial number. In an alternative embodiment, a local area network (LAN) would be utilized. The stored data would be accessed via the LAN onto a file server where the files are accessible for further evaluation or storage.

In an alternative embodiment, the present invention utilizes at least one servo-controlled hydraulic cylinder pushing against each end of the rack via the generally “U” shaped structure as a separate servo motor rotates the pinion. Load cells between the generally “U” shaped structure and the rack provide a feedback signal that is used by the servo controller to maintain a constant force against the rack. A torque transducer provides a feedback signal showing the torque required to turn the pinion. The motion and required drive torque of the pinion are compared against the force and position of the rack to verify the correct operation of the rack and pinion assembly. Another embodiment employs, in place of the at least one servo-controlled hydraulic cylinder, at least one ball-screw drive or electric cylinders that push the generally “U” shaped structure, with a force transducer such as a spring attached, against the rack. The compression of the springs provides the desired force.

The method and apparatus of the present invention are capable of measuring several functions of a rack and pinion steering gear assembly. For example, but not limited to testing of steering efforts, balance, perturbation, returnability, and fluid leakage may be tested. Furthermore, the method and apparatus of the present invention are not limited to use with a rack and pinion steering gear assembly, but may be used in accordance with the principles of the present invention to function test a number of devices such as rack and pinion assemblies used for linear actuations of mechanical devices, such as jacking devices.

An important factor when considering the advantage of the present invention over the prior art is the manner by which the force is applied to the test unit. A ball screw by nature provides a linear motion, with any force being a secondary outcome. If no reactive force is applied, no force is generated. The force applied to the rack is the force generated by the compression of the springs and to a much smaller extent, the mechanical elements of the ball screw and force transducer. In contrast, a linear motor by nature provides a force with position being a secondary outcome. If no reactive force is applied, the linear motor continues to apply the same force that will accelerate the linear motor coil until it reaches the end of its travel. When the linear motor is used in a positioning application position feedback is used to control the force applied by the linear motor in order to maintain the desired (commanded) position.

In order for the ball screw actuator of the prior art to apply a constant force to the rack, the ball screw actuator must be driven into the rack until the spring compresses and generates the force signal to the motion control operating the ball screw actuator. If this force signal is less than the desired force level, the ball screw actuator is commanded to move ahead, further compressing the force transducer and thereby increasing the force signal. If the force signal is greater than the desired force level, the ball screw actuator is commanded to back away, relaxing the compression of the force transducer and thereby decreasing the force signal. Maintaining the desired force level, while the rack is being driven by the pinion, is a very dynamic operation.

In contrast, for a linear motor to apply a constant force to the rack it only needs to be driven by a known current at the required voltage. The force generated by a linear motor is equal to the force constant of the motor times the applied current. The signal from the force transducer is then used to make minor adjustments to the motor current to compensate for friction, non-linearities of the motor, etc. This control method is more straightforward and less complex than the control scheme required for a ball screw actuator.

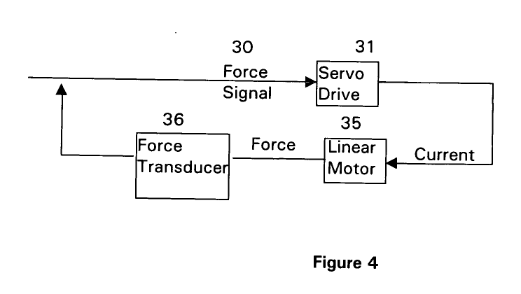

FIG. 4 illustrates the linear motor control. A force signal 30 is received by a servo drive 31. The servo drive 31 then corrects the current being applied to the linear motor 35, to achieve the desired force. The linear motor 35 then acts on the rack via the force transducer 36, which creates another force signal 30, thereby beginning the loop again.

A linear motor will also provide a more consistent force value, as the ball screw system is only capable of reacting to errors. No motion is generated except in reaction to an error in the force value. The linear motor applies the commanded force regardless of its position.

In one embodiment, the actuation is provided by linear servomotors, which provide several additional advantages over either the ball screw or hydraulic actuators. One advantage of linear servomotors is an increased accuracy and repeatability. With linear servomotors the only limit to total system accuracy and repeatability is the sensing device and the bearings of the positioning system. In rotary driven systems, there are additional factors that affect these performance variables. These factors include backlash, hysteresis, lost motion, jitter, etc.

Stiffness is also improved. Linear servo motors have very high stiffness. Linear servomotors are very stiff, typically stiffer than bearings and structural members of a system. For example, linear servo motors systems having a stiffness of 0.8 million N/mm, or 5 million lbs./inch, are achievable. With ball screws the couplings, bearings, and ball nut are the highest contributors to low stiffness of the system. Low stiffness reduces frequency response and increases settling times.

Maintenance and life expectancy of the present invention are also improved over the prior art. In a preferred embodiment, the linear servomotor is a brushless linear servomotor. Brushless linear servomotors have no contact between the two working members, the coil, and the magnets. Therefore, brushless linear servomotors have an extremely long, virtually maintenance-free life. The non-contact design eliminates lubrication and periodic adjustment to compensate for wear. Rotary driven mechanisms require regular lubrication and occasional replacement due to wear. For example, one such brushless linear servomotor which could be used in accordance with the principles of the present invention is sold under the designation 412LXR by Parker Hannifin Corporation, 6035 Parkland Boulevard Cleveland, Ohio 44124-4141.

A linear servo motor provides an increased smoothness of motion. A brushless linear servo motor can provide extremely smooth motion, since it has no contacting surfaces to cause jitter. By contrast, ball screws are not as smooth due to the vibrating nature of the balls entering and exiting the ball nut raceways.

The present invention also is capable of providing a more accurate force. As described above, the linear motor can provide a more accurate force to the rack than a ball screw actuator due to the manner in which the ball-screw actuator applies the force.

An additional advantage of the new apparatus in accordance with the present invention is that only one drive mechanism is required to provide the force on both ends of the rack; thus, reducing cost and improving reliability.

It should be understood that various changes and modifications preferred in to the embodiment described herein would be apparent to those skilled in the art. Such changes and modifications can be made without departing from the spirit and scope of the present invention and without demising its attendant advantages. It is therefore intended that such changes and modifications be covered by the appended claims.

1. A testing system comprising:
a testing station having an actuator with a generally “U” shaped structure comprising a first arm and a second arm; and
at least two force transducers.

2. The testing system of claim 1 further comprising a linear actuator functionally connected with the generally “U” shaped structure.

3. The testing system of claim 2, wherein the linear actuator comprises a linear servomotor.

4. The testing system of claim 1, wherein the at least two force transducers generate a force signal and, if the force signal is greater than a predetermined force level, then the actuator reduces the force it provides, thereby decreasing the force signal.

5. The testing system of claim 1, wherein the force transducer generates a force signal and, if the force signal is less than a predetermined force level, then the actuator increases a force it provides, thereby increasing the force signal.

6. The testing system of claim 1 further wherein the first arm and the second are each functionally connected to a force transducer, whereby the force transducer can monitor a force applied by the first arm and a force applied by a the second arm.

7. The testing system of claim 1, wherein the generally “U” shaped structure is adapted to function test a rack and pinion assembly.

8. The testing system of claim 7 further comprising a pinion drive functionally connected to the rack and pinion assembly.

9. The testing system of claim 8, wherein the pinion drive is functionally connected to a rack and pinion assembly input shaft by means of a torque transducer.

10. A testing device for function testing a rack having a first end and a second end, comprising:
a linear motor capable of being operatively connected to the rack and adapted to apply resistive force to the rack;
a force transducer adapted to reactively provide a force signal to the linear motor; and
an actuator capable of being operatively connected to the rack near the first end and near the second end;
wherein the actuator is adapted to apply force to the ends of the rack.

11. The testing device of claim 10, wherein the linear motor comprises a linear servomotor.

12. The testing device of claim 10 further comprising a controller wherein, if the force signal is greater than a predetermined force level, then the controller reduces the force generated by the linear motor.

13. The testing system of claim 10, wherein the force transducer generates a force signal and, if the force signal is less than a predetermined force level, then the actuator increases the force it provides, thereby increasing the force signal.

14. The testing device of claim 10 further comprising a pinion drive functionally connected to a rack and pinion assembly.

15. The testing device of claim 14, wherein the pinion drive is functionally connected to a rack and pinion assembly input shaft by means of a torque transducer.

16. The testing device of claim 10, wherein the actuator comprises a generally “U” shaped structure.

17. The testing device of claim 16, wherein the generally “U” shaped structure has a first arm, a second arm, and a base.

18. The testing device of claim 17, wherein the first arm and the second are each functionally connected to a force transducer, whereby the force transducer can monitor a force applied by the first arm and a force applied by the second arm.

19. The testing device of claim 16, wherein the generally “U” shaped structure is functionally attached to a linear motor stage containing the linear motor.

20. A method for function testing a device, comprising:
applying a known resistive force to the rack by means of the linear motor;
providing an applied force by means of an actuator to both ends of the rack; and
adjusting the applied force response to a force signal from a force transducer.

21. The method for function testing of claim 20 further comprising utilizing an actuator with a generally “U” shaped structure.

22. The method for function testing of claim 20 further comprising providing the applied force to both ends of the rack by means of a first arm and a second arm of the generally “U” shaped structure.

23. The method for function testing of claim 20 further comprising functionally connecting each arm of the generally “U” shaped structure to a force transducer.
